(19) United States
(12) Patent Application Publication
(10) Pub. No.: US 2026/0243603 A1
(43) Pub. Date: Aug. 20, 2026

(54) SYSTEM FOR DETECTING AN OBJECT AT LEAST PARTIALLY HIDDEN BY A FLAME

(71) Applicant: CONSIGLIO NAZIONALE DELLE RICERCHE, Roma (IT)

(72) Inventors: Massimiliano LOCATELLI, Roma (IT); Eugenio PUGLIESE, Roma (IT); Pasquale POGGI, Roma (IT); Stefano EUZZOR, Roma (IT); Riccardo MEUCCI, Roma (IT)

(73) Assignee: CONSIGLIO NAZIONALE DELLE RICERCHE, Roma (IT)

(21) Appl. No.: 19/160,862

(22) PCT Filed: Feb. 29, 2024
(86) PCT No.: PCT/EP2024/055219

§ 371 Date: Aug. 29, 2025

(30) Foreign Application Priority Data
Mar. 3, 2023 (IT) 102023000003936

(51) Int. Cl. G01J 5/0821; G01J 5/00; G01J 5/02; G01J 5/08; G01J 5/24

(52) U.S. Cl. CPC G01J 5/0821; G01J 5/0018; G01J 5/0265; G01J 5/0879; G01J 5/24; G01J 2005/0077

(57) ABSTRACT

It is disclosed a portable system for detecting an object at least partially hidden by a flame. The system comprises a first portable device comprising a fiber optic laser emitting an infrared radiation. The system also comprises a second portable device comprising a fiber optic splitter optically coupled to the fiber optic laser and an infrared detector. The fiber optic splitter divides the infrared radiation into an object beam and a reference beam, directs the object beam onto the object to be detected and directs the reference beam onto the infrared detector. The infrared detector detects a hologram formed by the reference beam interfering with the object beam scattered by the object. The system further comprises a data processing unit which reconstructs images of the object by numerically processing the hologram, and a display which visualizes the reconstructed images.

### FIELD OF THE INVENTION

The present invention relates to the field of systems for fire-fighting. In particular, the present invention relates to a system for detecting an object (in particular, but not exclusively, a human being) at least partially hidden by a flame.

### BACKGROUND OF THE INVENTION

The possibility of detecting objects (in particular, human beings) hidden by smoke and flames in fire scenes is of particular importance, especially in military and homeland security situations, in industrial sites and, generally, in the security field.

White-light detectors and visible wavelength sensors can not be used to this purpose, because wavelengths in the visible spectrum undergo strong scattering by smoke particles.

On the other hand, thermographic detectors employing, for example, an array of bolometers operating in an infrared wavelength region (e.g. 7-14 μm) are able to detect objects hidden by smoke. Such detectors allow clear vision (in particular with laser IR illumination) through smoke, since radiation in the infrared region is scattered just slightly by smoke particles.

However, thermographic detectors are not capable of detecting objects hidden by flames. Such detectors, indeed, typically comprise an objective lens which focuses radiation emitted or scattered by the object onto the thermographic detector. Such objective lens disadvantageously focuses on at least some of the bolometers also the infrared radiation emitted by flames and matching the numerical aperture of the lens. Such focused radiation disadvantageously may induce saturation of the bolometers and, in any case, hides the contribution provided by the object, so that the image of the object on the focal plane array exhibits blind areas where the object is hidden by flames.

US 2015/0160613 A1 in the name of the same Applicant discloses a system and method for reconstructing an image of an object at least partially hidden by a flame which makes use of digital holography at infrared wavelengths. Specifically, the system comprises a laser source emitting an infrared radiation and a lens-less off-axis interferometric arrangement that divides the infrared radiation into an object beam and a reference beam. The object beam is enlarged and then irradiates the object, that scatters it. The reference beam is enlarged and then interferes with the scattered object beam, so as to create a hologram. The system comprises an infrared detector which detects the hologram and a data processing unit which reconstructs the image of the object by numerically processing the hologram. The system therefore provides the object image based on digital holography at infrared wavelengths. Differently from known thermographic acquisition techniques, even if large portions of the object, or even the entire object, are hidden by the flame, the system of US 2015/0160613 A1 allows to reconstruct an image of the whole object, with no blind areas.

CN 110 045 587 and CN 108 732 903 disclose fire scene search and rescue devices based on infrared holographic technology.

### SUMMARY OF THE INVENTION

The Applicant has perceived the need to improve the system disclosed by the above prior art documents.

The system disclosed by US 2015/0160613 A1 indeed makes use of infrared radiation at wavelength comprised between 3 μm and 1 mm, more preferably between 3 μm and 30 μm, even more preferably between 8 μm and 12 μm. Similarly, the systems of CN 110 045 587 and CN 108 732 903 make use of infrared radiation at a wavelength comprised between 8 μm and 13 μm. Typical laser sources capable of emitting in such wavelength range are CO₂ lasers, which, in general, are bulky and heavy. Moreover, even if use of the infrared radiation in the above wavelength range reduces, to some extent, the sensitivity of the interferometric arrangement to vibrations in comparison e.g. to systems using visible radiation, nonetheless the sensitivity to vibrations is still quite high. Hence, the system cannot be handheld.

For these reasons, the system disclosed by the above prior art documents is not suitable for being implemented as a portable system.

In view of the above, the Applicant has faced the problem of providing a system capable of detecting objects hidden by the flame which is portable, so that firefighters and first responders may carry it with them to coordinate the rescue operations and work safely in hostile environments.

According to embodiments of the present invention, this and other problems are solved by a system for detecting an object (in particular, but not exclusively, a human being) at least partially hidden by a flame, comprising a first portable device and a second portable device; the first portable device comprises a fiber optic laser suitable for emitting an infrared radiation; the second portable device comprises a fiber optic splitter optically coupled to the fiber optic laser and an infrared detector; the fiber optic splitter is configured to divide the infrared radiation into an object beam and a reference beam, to direct the object beam onto at least a portion of the object to be detected and to direct the reference beam onto the infrared detector; the infrared detector is configured to detect a hologram formed by the reference beam interfering with the object beam scattered by the at least a portion of the object; the system also comprises a data processing unit configured to reconstruct at least one image of the object by numerically processing the hologram and a display configured to visualize the at least one reconstructed image.

The system according to embodiments of the present invention is advantageously portable. The fiber optic laser is indeed light and compact, and is then transportable in the first portable device, which for example may be in the form of a wearable device such as a backpack. Besides, the interferometric arrangement comprising fiber optic splitter and infrared detector is transportable in the second portable device, which for example may be in the form of a very light and compact handheld unit which the firefighter or first responder may grip as a flashlight to illuminate the fire scene. Firefighters and first responders may then easily carry the system with them to coordinate the rescue operations and work safely in hostile environments.

Further, physically decoupling the fiber optic laser and the interferometric arrangement in two separated portable devices provides advantages in terms of sensitivity to vibrations of the system. The second portable device which houses the interferometric arrangement is indeed very light and compact, and then may be mechanically stabilized by any known stabilization system, for example a gimbal system. The stabilization system advantageously reduces sensitivity to vibrations of the interferometric arrangement and then, since the first portable device does not need any vibration attenuation, of the whole system.

Further, use of a fiber optic laser allows reducing the wavelength of the infrared radiation to a range lower than the one used in the systems of the above prior art documents, specifically in the range lower than 3 μm, preferably between 1.4 μm and 2.95 μm, for example 1.55 μm. Such wavelength range is considered eye safe and allows using very sensitive infrared detectors, such as for example an InGaAs (Indium Gallium Arsenide) detector. The increased sensitivity of the infrared detector allows reducing the exposure time of the hologram. For example, the exposure time may be 100 μs, or even 10 μs. Such reduction of the exposure time advantageously results in a reduced sensitivity of the whole system to vibrations, and makes it possible to handheld the system without destroying the interferometric pattern. Furthermore, the exposure time reduction allows eliminating, or at least contrasting, the disturbance to the fringe visibility (and ultimately to the reconstructed image) caused by the turbulence of the flames and the smoke, which could be very destructive in a fire scenario.

Moreover, the increased sensitivity of the infrared detector allows reducing the output power of the fiber optic laser (1-10 W), thereby significantly increasing the safety of the whole system.

According to a first aspect, the present invention provides a system for detecting an object at least partially hidden by a flame, the system comprising:
a first portable device comprising a fiber optic laser suitable for emitting an infrared radiation;
a second portable device comprising a fiber optic splitter optically coupled to the fiber optic laser and an infrared detector, the fiber optic splitter being configured to divide the infrared radiation into an object beam and a reference beam, to direct the object beam onto at least a portion of the object and to direct the reference beam onto the infrared detector, the infrared detector being configured to detect a hologram formed by the reference beam interfering with the object beam scattered by the at least a portion of the object,
wherein the system further comprises a data processing unit configured to reconstruct at least one image of the object by numerically processing the hologram, and a display configured to visualize the at least one reconstructed image.

According to an embodiment, the first portable device is a wearable device, for example a backpack.

According to an embodiment, the second portable device is a handheld unit.

Preferably, the infrared radiation has a wavelength lower than 3 μm and/or a maximum output power of 10 W.

Preferably, the infrared radiation is linearly polarized.

Preferably, the second portable device is provided with an outer casing having at least one opening provided with an optically transparent window capable of allowing passage of the infrared radiation in both directions.

Preferably, the fiber optic laser is provided with an output optical fiber suitable for exiting the first portable device and for being removably coupled with the fiber optic splitter comprised in the second portable device.

Preferably, the infrared detector has a frame rate up to 230 frame/s and/or a maximum exposure time of 500 μs (for example 100 us or 10 μs).

According to embodiments, the data processing unit is positioned in the first portable device or in the second portable device.

According to embodiments, the display is positioned on the second portable device or in a third portable device other than the first portable device and second portable device.

Preferably, the second portable device is provided with a stabilization system configured to reduce sensitivity to vibrations of the hologram formed by the reference beam interfering with the object beam scattered by the at least a portion of the object.

According to embodiments, the second portable device further comprises at least one of:
an optical system suitable for maximizing the optical power of the object beam scattered by the object and directed to the infrared detector;
a beam splitter located on the optical path of the reference beam and configured to combine the reference beam and the object beam scattered by the object;
an adjustable collimator located on the optical path of the object beam and suitable for adjusting the size of the object beam directed onto at least a portion of the object;
a further adjustable collimator located on the optical path of the reference beam and suitable for adjusting the size of the reference beam; and
a variable attenuator located on the optical path of the reference beam and suitable for adjusting the intensity of the reference beam such that the reference beam and the object beam scattered by the object are received at the infrared detector with comparable intensities.

According to a second aspect, the present invention provides a method for detecting an object at least partially hidden by a flame, the method comprising:
by a fiber optic laser comprised in a first portable device, emitting an infrared radiation;
by a fiber optic splitter optically coupled to the fiber optic laser and comprised in a second portable device, dividing the infrared radiation into an object beam and a reference beam, directing the object beam onto at least a portion of the object and directing the reference beam onto an infrared detector also comprised in the second portable device;
by said infrared detector comprised in the second portable device, detecting a hologram formed by the reference beam interfering with the object beam scattered by the at least a portion of the object, and
by data processing unit, reconstructing at least one image of the object by numerically processing the hologram and a display configured to visualize the at least one reconstructed image.

### BRIEF DESCRIPTION OF THE DRAWINGS

The present invention will become clearer from the following detailed description, given by way of example and not of limitation, to be read with reference to the accompanying drawings, wherein:

FIG. 1 schematically shows a system according to a first embodiment of the present invention;

FIG. 2 is a flow chart showing the operation of the systems of FIG. 1;

FIG. 3 is a flow chart showing a variant of the operation of the system of FIG. 1; and

FIG. 4 schematically shows a system according to a second embodiment of the present invention.

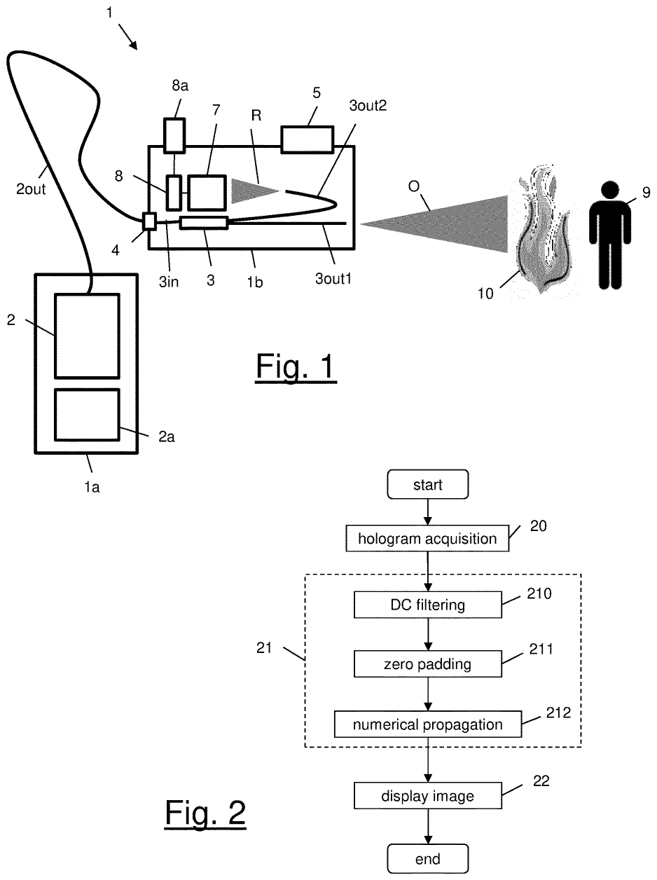

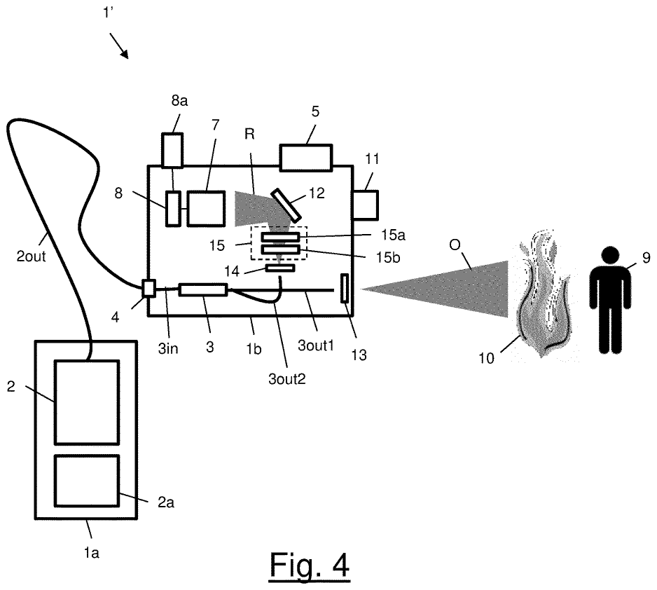

FIGS. 1 and 4 are not in scale.

### DETAILED DESCRIPTION OF EMBODIMENTS OF THE INVENTION

FIG. 1 shows a system 1 for detecting an object 9 (in particular, but not exclusively, a human being) at least partially hidden by a flame 10, according to a first embodiment of the present invention.

The system 1 preferably comprises a first portable device 1a and a second portable device 1b. The first portable device 1a preferably comprises a fiber optic laser 2. The second portable device 1b preferably comprises a fiber optic splitter 3 and an infrared (IR) detector 7.

The fiber optic laser 2 is preferably suitable for emitting a radiation in the infrared region. In particular, the emission wavelength of the fiber optic laser 2 is preferably lower than 3 μm. More preferably, the emission wavelength of the fiber optic laser 2 is comprised between 1.4 μm and 2.95 μm. For example, the emission wavelength of the fiber optic laser 2 is equal to 1.55 μm.

Preferably, the maximum output power of the fiber optic laser 2 is 10 W, more preferably 5 W, even more preferably 1 W. The preferred range for the output power of the laser source 2 mainly depends on the distance d between object 9 and surface of the IR detector 7, on the object size D and on the detector sensitivity. Assuming to irradiate the object 9 in a substantially uniform way (and disregarding air absorption), the inventors have estimated that, if the distance d is increased by a factor n, the output power of the laser source 2 shall be increased by a factor n². The inventors have estimated that, for reconstructing the image of a 1 m diameter object 9 placed at a distance d of about 10 m from the system 1, an output power higher than 1W is enough. Besides, the output power of the laser source 2 should be kept as low as possible in order not to damage the surface of the object 9 (especially in case of biological tissues of a living object).

Further, the infrared radiation emitted by the fiber optic laser 2 is preferably linearly polarized. Further, preferably, the infrared radiation emitted by the fiber optic laser 2 has a sufficiently high coherence length (e.g. frequency bandwidth lower than 5 MHZ) in order to allow working within a desired distance between the object 9 and the IR detector 7 (e.g. 10 m), with no need to balance the lengths of the optical paths of the object and reference beams. More preferably, the frequency bandwidth of the fiber optic laser 2 is lower than 1 MHz, in order to allow working within a distance of about 50 m between the object 9 and the IR detector 7, with no need to balance the length of the optical paths of the object and reference beams. The inventors have made positive tests using a fiber optic laser FL-1550-SF by Changchun New Industries Optoelectronics Tech. Co., Ltd. (CNI) based in Changchun (China), emitting linearly polarized radiation at 1.55 μm with a maximum output power of 1 W and a frequency bandwidth lower than 5 MHz.

The first portable device 1a also preferably houses a battery 2a suitable for powering the fiber optic laser 2.

The fiber optic laser 2 is preferably provided with an output optical fiber 2out suitable for coupling the emitted infrared radiation into the fiber splitter 3. More specifically, the fiber optic splitter 3 is preferably provided with an input optical fiber 3 in and two output optical fibers 3out1, 3out2. The output optical fiber 2out of the fiber optic laser 2 is preferably suitable for being removably connected to the input optical fiber 3 in of the fiber optic splitter 3. The removable connection between output optical fiber 2out of the fiber optic laser 2 and input optical fiber 3 in of the fiber optic splitter 3 is preferably implemented by means of an optical connector 4, such as a PC (Physical Contact) optical connector or an APC (Angled Physical Contact) optical connector. The output optical fiber 2out may have a length for example comprised between 1 m and 5 m.

The fiber optic splitter 3 is suitable for dividing the infrared radiation received from the fiber optic laser 2 through the input optical fiber 3 in into a first beam (also termed herein after “object beam O”) and a second beam (also termed herein after “reference beam R”), for directing the object beam O onto the object 9 and for directing the reference beam R onto the IR detector 7. Each one of the object beam O and reference beam R is preferably output through a respective output optical fiber 3out1, 3out2 of the fiber optic splitter 3. More specifically, the output optical fiber 3out1 is directed towards the object 9 so that, thanks to its divergence, the object 9 is efficiently irradiated. Similarly, the output optical fiber 3out2 is directly directed towards the IR detector 7 so that, thanks to its divergence and to its distance from the IR detector 7, substantially the entire surface of the detector 7 is almost uniformly irradiated. The object beam O then irradiates the object 9, that scatters it. At the IR detector 7, the reference beam R interferes with the scattered object beam O thereby creating an interference pattern, namely a hologram.

In order to allow the object beam O as emitted by the output optical fiber 3out1 irradiating the object 9 and the object beam O as scattered by the object 9 reaching the IR detector 7, the second portable device 1b is preferably provided with an outer casing having at least one opening (not depicted in FIG. 1). The opening may be provided with an optically transparent window capable of allowing passage of the infrared radiation in both directions (namely, from inside the second portable device 1b towards the outside and vice versa).

The fiber optic splitter 3 is preferably configured such that the reference beam R and the object beam O scattered by the object 9 are received at the IR detector 7 with comparable intensities. The fiber optic splitter 3 is also preferably configured such that substantially the full dynamic range of the IR detector 7 is used to record the interferometric pattern. However, when the intensity of the object beam O is so low that the dynamic range of the IR detector 7 cannot be efficiently used, it is profitable to increase the intensity of the reference beam R (paying attention, of course, not to saturate the IR detector 7) in order to maximise the signal-to-noise ratio (SNR). To this purpose, it is preferable to use a fiber optic splitter 3 with a splitting ratio suitable for providing a sufficiently high intensity of the reference beam R and, when needed, to attenuate it. However, considered that the intensity of the object beam O is strongly reduced by the scattering on the surface of the object 9 and that it attenuates significantly with the distance between object 9 and IR detector 7, most of the infrared radiation emitted by the fiber optical laser 2 is preferably directed to the object beam O. Hence, preferably, the fiber optic splitter 3 is configured such that the optical power of the object beam O is higher than 80% of the total optical power of the infrared radiation received by the fiber optic splitter 3, more preferably higher than 90%, even more preferably higher than 99%. The inventors have made positive tests using a fiber optic splitter PN1550R1A1 (155 nm 1×2 Polarization-Maintaining Fiber Optic Coupler) by Throlabs Inc. based in Newton (New Jersey, United States), configured such that the optical power of the object beam O is 99% of the total optical power of the infrared radiation received by the fiber optic splitter 3, and the optical power of the reference beam R is accordingly 1% of the total optical power of the infrared radiation received by the fiber optic splitter 3.

The IR detector 7 is configured to detect the interference pattern of object beam O and reference beam R. The IR detector 7 preferably is a thermocamera comprising a 2D array of N×M detector elements (or pixels). The IR detector 7 preferably is an InGaAs detector. The inventors have made positive tests using a detector WiDy SenS 640 manufactured by New Imaging Technologies (NIT) based in Verrières le Buisson (France), with 640×512 pixels, a pixel size of 15 μm×15 μm, a frame rate up to 230 frame/s, an exposure time from 10 μs to 1 s and spectral response in the range 0.9 μm-1.7 μm.

The fiber optic splitter 3 and IR detector 7 therefore act as an off-axis holographic arrangement, namely an interferometric arrangement wherein the two interfering beams (namely, object beam O and reference beam R) are not focused on the surface of the IR detector 7 (lensless) and are reciprocally tilted by a non-null angle as they impinge on the surface of the IR detector 7 (off-axis).

The system 1 also preferably comprises a data processing unit 8 cooperating with the IR detector 7. The data processing unit 8 is preferably configured to receive from the IR detector 7 the detected interference pattern in a discretised form, to store it and to process it, as it will be discussed in detail herein after. The data processing unit 8 is also preferably provided with a display 8a suitable for displaying the images reconstructed from the holograms.

The data processing unit 8 preferably is a portable unit. For example, the data processing unit 8 may be in the form of an FPGA unit. The data processing unit 8 may be positioned either in the first portable device 1a or, as depicted in FIG. 1, in the second portable device 1b. As to the display 8a, it is preferably positioned such that the operator may easily see it as he carries the system 1. For example, the display 8a may be positioned on the outer casing of the second portable device 1b, as schematically depicted in FIG. 1. Alternatively, the display 8a may be incorporated in a third portable device (not depicted in FIG. 1) physically separated from the first portable device 1a and second portable device 1b, for example googles.

The system 1 is advantageously portable. The fiber optic laser 2 is indeed light and compact, and is then transportable in the first portable device 1a, which for example may be in the form of a backpack. Besides, the interferometric arrangement comprising fiber optic splitter 3 and IR detector 7 is transportable in the second portable device 1b, which for example may be in the form of a very light and compact handheld unit which the firefighter or first responder may grip as a flashlight to illuminate the fire scene. Firefighters and first responders may then easily carry the system 1 with them to coordinate the rescue operations and work safely in hostile environments.

Further, physically decoupling the fiber optic laser 2 and the interferometric arrangement in two physically separated portable devices 1a, 1b provides advantages in terms of sensitivity to vibrations of the system 1. The second portable device 1b which houses the interferometric arrangement is indeed very light and compact, and then may be mechanically stabilized by any known stabilization system, schematically depicted in FIG. 1 and indicated with reference number 5. The stabilization system 5 may be for example a gimbal system. The stabilization system 5 advantageously reduces sensitivity to vibrations of the interferometric arrangement and then, since the first portable device 1a does not need any vibration attenuation, of the whole system 1.

Further, use of the fiber optic laser 2 allows reducing the wavelength of the infrared radiation to a range lower than the one used in the systems of the prior art documents, specifically in the range lower than 3 μm, preferably between 1.4 μm and 2.95 μm, for example 1.55 μm. Such wavelength range allows using a very sensitive IR detector 7, such as for example an InGaAs (Indium Gallium Arsenide) detector. The increased sensitivity of the IR detector 7 allows reducing the exposure time of the hologram. For example, the exposure time may be 100 μs, or even 10 μs. Such reduction of the exposure time advantageously results in a reduced sensitivity of the whole system 1 to vibrations, and makes it possible to handheld the system 1 without destroying the interferometric pattern. Furthermore, the exposure time reduction allows eliminating, or at least contrasting, the disturbance to the fringe visibility (and ultimately to the reconstructed image) caused by the turbulence of the flames and the smoke, which could be very destructive in a fire scenario.

Moreover, the increased sensitivity of the IR detector 7 allows reducing the output power of the fiber optic laser 2 (1-10 W), thereby significantly increasing the safety of the whole system 1.

The operation of the system 1 according to an embodiment of the present invention will be now described with reference to the flow chart of FIG. 2.

The operation of system 1 is preferably divided into two separate steps: an optical acquisition step 20 and a numerical processing step 21.

During the optical acquisition step 20, the system 1 is brought into proximity of the object 9 at least partially hidden by flame 10. For this purpose, as mentioned above, the second portable device 1b may be gripped as a flashlight to illuminate the fire scene. The distance d between system 1 (in particular, the second portable device 1b) and object 9 depends on the environment conditions, on the extent of the flame 10, etc.

Then, the fiber optic laser 2 is switched on and starts emitting an infrared radiation. The infrared radiation is divided by the fiber optic splitter 3 into the object beam O and the reference beam R. The object beam O irradiates a surface of the object 9. The extent of the irradiated surface depends on the distance d between system 1 (in particular, second portable device 1b) and object 9. The object beam O is therefore scattered by the irradiated surface of the object 9, and then reaches the IR detector 7.

On the other hand, the reference beam R is directly directed onto the IR detector 7.

The object beam O scattered by object 9 and the reference beam R then interfere on the surface of the IR detector 7, thereby creating a 2D interference pattern, or hologram, of the object 9, which is detected by the IR detector 7.

The hologram exhibits interference fringes having a certain fringe spacing. The hologram may be described in terms of 2D distribution of intensity according to the following equation:

$$H ( x , y ) = {\vert R \vert}^{2} + {\vert O \vert}^{2} + {R}^{★} \cdot O + R \cdot {O}^{★} \qquad [ 1 ]$$

where x and y are the two spatial coordinates of the surface of the IR detector 7, whereas R* and O* are the conjugate complex of the reference beam R and object beam O, respectively.

Sensitivity of the system 1 to vibrations is advantageously reduced by a reduced exposition time and/or by the stabilization system 5 of the second portable device 1b, so that the system 1 can be handheld without destroying the interferometric pattern between object beam O and reference beam R.

Since the IR detector 7 is only sensitive to infrared radiations, the component of the artificial light or sunlight in the visible range do not disrupt operation of the system 1 at step 20. Besides, the infrared component of the artificial light, sunlight and flame does not impair the operation of system 1, because it is incoherent with object beam O and reference beam R, and accordingly merely represents a background noise. In any case, an optical band pass spectral filter (not depicted in FIG. 1) centered around the emission wavelength of the fiber optic laser 2 may be optionally provided in front of the IR detector 7, in order to filter out the infrared component of artificial light, sunlight and flame.

The interference pattern or hologram acquired by the IR detector 7 (or, rather, its discretized version) is then stored by the data processing unit 8. A single hologram of the object 9 may be acquired and stored. Alternatively, multiple consecutive holograms of the object 9 may be acquired and stored, e.g. in a form of a video if a dynamic scene is of interest.

Then, the data processing unit 8 carries out the numerical processing step 21 onto the discretized hologram. The numerical processing is preferably as that described in US 2015/0160613. Specifically, during a first sub-step 210, the hologram is preferably filtered, so as to cancel the DC term or zeroth diffraction order, namely the term |R|²+|O|² of equation [1]. Since the system 1 has an off-axis configuration (namely the reference beam R and object O impinge on the IR detector 7 with different angles), such DC term |R|²+|O|² is advantageously spatially non superimposed to the other terms R*·O+R·O*, and accordingly may be filtered out in the spatial frequency domain.

Then, during a second sub-step 211, a zero padding operation is preferably applied to the hologram, namely the array of N×M pixels of the filtered, discretized hologram is extended by introducing a number of additional fictitious pixels, the intensity of which is set to zero. Preferably, the zero padding operation is that described in EP 1 654 596, in the name of the same Applicant.

In fact, as known in digital holography, for reconstructing an image of an object starting from the acquired hologram, a mathematical algorithm derived from the diffraction theory is executed, in particular a mathematical algorithm implementing the known Rayleigh-Sommerfeld formula. Such formula basically contains a double integration of the digitalized hologram multiplied by a numerical copy of the reference beam R and other terms. Such double integration, in principle, involves considerable calculating effort. However, its numerical implementation may be simplified by converting the integrals in Fourier transforms. Indeed, since the hologram is discretized, the Fourier transforms actually are discrete Fourier transforms, which may be easily calculated by means of known FFT (Fast Fourier Transform) algorithms. To operate the transformation, in particular, two methods are known: the convolution method and the Fresnel method. The Fresnel method is advantageous over the convolution method, in that it involves one single Discrete Fourier Transform (DFT) which can be easily implemented by means of the FFT algorithm. The spatial resolution of the reconstructed image is quantified by the so-called “reconstruction pixel”, whose sizes along the directions x and y are given by the following equations:

$$\begin{matrix}Δξ = \frac{λ \cdot d}{N \cdot Δ x} & Δη = \frac{λ \cdot d}{M \cdot Δ y}\end{matrix} \qquad [ 2 ]$$

where N and M are the number of pixels of the acquired discretized hologram along the directions x and y, λ is the emission wavelength of the laser source 2, d is the reconstruction distance (namely, the distance between object 9 and IR detector 7 and Δx and Δy are the pixel sizes of the IR detector 7 along the directions x and y. From the above equation [2], it is apparent that Δξ and Δη are proportional to the wavelength λ and the reconstruction distance d, whereas they decrease with the number of pixels N×M and the pixel physical size. Consequently, spatial resolution of the reconstructed image may be worst than the physical one imposed by the sampling theorem, depending on the values of the parameters of equations [2].

The zero padding operations mentioned above advantageously allows enhancing the spatial resolution of the reconstructed image. More specifically, by adding fictitious pixels with null intensity to the N×M array of the acquired hologram, Δξ and Δη are reduced and the spatial resolution is increased. Preferably, the fictitious pixels are added as contour of the acquired hologram, that is without interleaving them among the effective pixels. This assures that no spurious frequencies arise in the reconstructed image as a consequence of the discontinuities that such interleaving would introduce. The number of fictitious pixels depends on the desired resolution in the reconstruction of the image. The maximum resolution which may be obtained is equal to the physical boundary established by the sampling theorem.

Although the advantages of the zero padding operation have been discussed above with reference to the Fresnel method only (where zero padding basically allows compensating the resolution reduction entailed by use of a longer wavelength, see above equations [2]), the zero padding operation may be used in combination with other methods, such as angular spectrum method or convolution method.

Then, at a third sub-step 212, the acquired discretized hologram (filtered at sub-step 210 and possibly “enlarged” at sub-step 211) is processed for reconstructing an image of the object 9.

Such sub-step 212 in particular comprises applying to the acquired discretized hologram (filtered and possibly “enlarged”) a mathematical algorithm implementing the above mentioned known Rayleigh-Sommerfeld formula which basically emulates the diffraction effects of the propagation of a numerical copy of the reference beam R across the hologram and gives, as a result, the object wavefront reconstruction, focussed at the distance d. Preferably, the algorithm is based on the above mentioned Fresnel method, which is particularly easy and fast in comparison to other known methods. However, according to other variants, other numerical focusing methods can be used, for instance the angular spectrum method or the convolution method.

The execution of the numerical focussing of sub-step 212 provides a complex reconstructed wavefield, namely a matrix wherein each element or pixel of the matrix is a complex number. Sub-step 212 preferably further comprises calculating the amplitude of the complex reconstructed wavefield by calculating the amplitude of each pixel of the matrix separately, namely by calculating the modulus of each complex number of the matrix. The resulting matrix is the amplitude of the complex reconstructed wavefield, namely the reconstructed image of the object 9.

Sub-step 212 also preferably comprises filtering the complex conjugate of the complex reconstructed wavefield, which is provided by the numerical focussing of the hologram.

Further, sub-step 212 may comprise other numerical processing operations on the hologram and/or the complex reconstructed wavefield, e.g. for improving the signal-to-noise ratio of the reconstructed image.

The reconstructed image is then preferably displayed on the display 8a of the data processing unit 8 (step 22).

Therefore, the system 1 is capable of providing images of objects based on an interferometric technique, namely digital holography, at infrared wavelengths. As discussed in US 2015/0160613 A1, this has a number of advantages.

First of all, differently from known visible and thermographic acquisition technique, even if large portions of the object or even all of the object 9 is hidden by the flame 10, the system 1 allows to see through the flame 10 thereby providing an image with no blind zones, without significant resolution loss. This is due to some intrinsic features of digital holography.

Firstly, since the system 1—and, in particular, the interferometric arrangement housed in the second portable device 1b—does not comprise any lens which focuses the radiation impinging on the IR detector 7, the infrared radiation emitted by the flame 10 is not focused on the IR detector 7, but is instead distributed over its whole surface. Hence, no image of the flame 10 is formed on the surface of the IR detector 7 and, consequently, no pixel saturation is induced. In other words, the IR detector 7 acquires the image of the object 9 out-of-focus, and accordingly the saturation effect which is observed in the known thermographic acquisition technique is avoided and the IR detector 7 is not blinded by the flame emission.

Besides, the infrared radiation emitted by the flame 10 is incoherent with reference beam R and object beam O and accordingly does not take part to the formation of the interference fringes of the hologram. The infrared radiation emitted by the flame 10 accordingly is only a background noise, which is distributed on the whole surface of the IR detector 7.

Furthermore, thanks to the ability of holography to reconstruct entirely an image of the object wavefront from a smaller portion of the hologram, system 1 allows reconstruction of the whole image even if some pixels are accidentally saturated or if some micro-particles, often present in fire scenarios, obstruct direct imaging.

For all such reasons, the system 1 advantageously allows reconstructing the image of the object 9 behind the flame 10.

The system 1 has further advantages.

First of all, thanks to the use of an IR wavelength lower than 3 μm, it is possible to reconstruct images of human-size objects at a reasonable distance, thanks to the larger field of view of Digital Holography in the IR range with respect to Digital Holography in the visible range.

Furthermore, laser sources suitable for emitting IR wavelengths lower than 3 μm (e.g. fiber optic lasers) are broadly available with good spatial and temporal coherence properties, so it is possible to expand the object beam O to irradiate large scenes and to obtain high visibility interference fringes even with a very high imbalance between the object beam path and the reference beam path.

The system 1 therefore allows providing real-time reconstructed images of live, moving people in fire scenes, e.g. with people trapped in an apartment invaded by flames, where naked-eye vision is completely impaired. In this case, a thermographic camera would not be able to return a view of the people inside the apartment, because of flame emissions. The system 1, based on digital holography, is instead capable of discarding the flame contributions and offers a clear view of any people behind them.

Clear images are advantageously obtained, independently of the chemical nature of the burning materials involved and from their emission spectrum. Therefore, the described system 1 can be advantageously used for reconstructing images of objects at least partially hidden by any kind of flames.

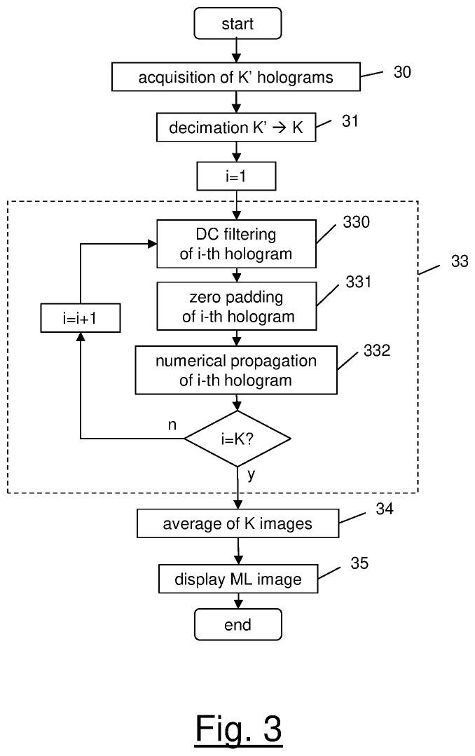

The operation of the system 1 according to a variant will be now described with reference to the flow chart of FIG. 3.

According to this variant, the system 1 carries out a speckle noise reduction operation.

The system 1 is indeed an imaging system employing a coherent laser source and, as such, its performance is degraded by coherent noise and, especially, correlated speckle noise. As known, speckle noise is a multiplicative noise that occurs when a coherent light hits targets whose roughness varies on the same scale of the light wavelength. In this case, each detector element of the IR detector 7 detects the coherent superposition of a number of different scattering contributions. As the scattering contributions experience microscopically different paths, their phases can be variable and the result of their coherent superposition at the IR detector 7 is a succession of dark and bright spots, known as “speckle noise”. As a result, the quality of the image reconstructed from the acquired hologram decreases in terms of contrast and pixel resolution.

As known, speckle noise may be quantified using a statistical approach. In particular, a known way to obtain indications about the speckle noise extent is to measure the speckle contrast C as follows:

$$C = \frac{σ}{μ} \qquad [ 3 ]$$

where σ and μ denote the standard deviation and the mean amplitude of the image, respectively. Furthermore, a punctual measure of the intensity variations due to speckle noise may be obtained by calculating the relative deviation of the image as:

$${R}_{DEV} ( x , y ) = \frac{I ( x , y ) - \overline{I}}{\overline{I}} \qquad [ 4 ]$$

where I(x,y) is intensity of the pixel of the reconstructed image and Ī a mean intensity calculated over the whole image. In particular, if a portion of a homogeneous part of the image is chosen, smooth behaviour of its intensity should be expected. So, any rapid variations and sudden spikes in its intensity have to be attributed to speckle in those points where interference has been strongly destructive or constructive.

In order to reduce the speckle contrast, according to the second variant shown in FIG. 3, several holograms (in particular, K′ holograms) of the object 9 are preferably acquired by the IR detector 7 at different times (step 30). Use of infrared radiation at a wavelength lower than 3 μm (e.g. 1.55 μm) is advantageous in this respect, because IR detectors operating in such wavelength range typically have a frame rate much lower than IR detectors operating at higher wavelengths, for example 10.6 μm. The frame rate of IR detectors operating at 10.6 μm is indeed typically limited to 50 frame/s, while IR detectors operating at 1.55 μm may have a frame rate up to 230 frame/s. The overall acquisition time of the K′ holograms is therefore advantageously reduced.

Then, optionally, the K′ holograms may be decimated for extracting K<K′ holograms (step 31). K is preferably comprised between 2 and 20, more preferably between 3 and 10. For instance, the K holograms may be obtained by selecting a hologram every Q holograms acquired by the IR detector 7. This provides K holograms whose acquisition times are substantially equispaced in time. The inter-acquisition time of the K holograms (namely, the time interval between two consecutive holograms of the decimated sequence of K holograms) depends both on the frame rate of the IR detector 7 and Q. Given a certain frame rate of the IR detector 7, Q is preferably selected so that the inter-acquisition time of the selected K holograms is long enough to ensure a certain uncorrelation between them. For instance, with a frame rate of 230 frames/seconds, the K holograms may be obtained by selecting one hologram every Q=50 acquired holograms. This provides an inter-acquisition time of about 0.2 seconds, which is long enough for vision through flames (flames introduce a uncorrelation faster than smoke, which would require a longer inter-acquisition time). On the other hand, the inter-acquisition time of the K holograms shall be low enough to ensure that, during acquisition of the K holograms, the object 9 is substantially still. Decimation allows an in-line selection of the K holograms, namely the hologram selection is performed while the K′ holograms are acquired. Alternatively, at step 31 the K holograms may be selected off-line, namely after the acquisition of the K′ holograms is completed. According to such embodiments, the selection of the K holograms may be carried out e.g. by optimizing a metric indicative of the image quality, e.g. of its signal-to-noise ratio.

Then, each one of the K holograms is preferably subjected to a numerical processing step 33 similar to the numerical processing step 21 of FIG. 2. In particular, the numerical processing step 33 comprises, for each hologram, a DC filtering sub-step 330, a zero padding sub-step 331 and a numerical propagation sub-step 332. For a detail description of such sub-steps, reference is made to the above description of the flow chart of FIG. 2. As a result, an image is preferably reconstructed from each one of the K holograms. As mentioned above, each image in particular is obtained by calculating the amplitude (or modulus) of each pixel of the complex reconstructed wavefield matrix resulting from the numerical focussing carried out at sub-step 332.

Then, an average of the K images is calculated (step 34), which provides a multi-look (ML) image. The average in particular is calculated by carrying out an incoherent, pixel-by-pixel sum of the amplitude matrixes derived from the K holograms, divided by K.

The multi-look image is then displayed by the display 8a (step 35).

The speckle contrast C of the multi-look image may be advantageously reduced by a factor up to \sqrt{K} in comparison to the speckle contrast of each single image. It is indeed known that the sum of K uncorrelated random variables having a same mean μ_{Xi} and a same variance σ_{Xi} has a variance equal to the variance σ_{Xi} of the single variable divided by \sqrt{K}. From equation [3] above it is therefore directly derived that the speckle contrast C_{\tilde{X}} of the multi-look image resulting from step 34 is:

$${C}_{\tilde{X}} = \frac{1}{\sqrt{K}} \frac{{σ}_{Xi}}{{μ}_{Xi}} = \frac{1}{\sqrt{K}} {C}_{Xi} \qquad [ 5 ]$$

where C_{Xi} is the speckle contrast of each single image. Hence, the averaging operation carried out at step 44 would reduce the speckle contrast by a factor \sqrt{K}, if the K images were totally uncorrelated. However, since (in spite of the uncorrelation introduced by the flame) a certain correlation degree still exists between the K images, the actual speckle contrast improvement is smaller.

FIG. 4 shows a system 1′ according to a second embodiment of the present invention.

The system 1′ comprises some additional components with respect to the system 1 shown in FIG. 1. The additional components shown in FIG. 4 are optional and may be included in the system singularly or jointly in any combination thereof. Specifically, in addition to the components depicted in FIG. 1, the second portable device 1b of the system 1′ optionally comprises an optical system 11 suitable for maximizing the optical power of the object beam O collected and directed to the IR detector 7. The optical system 11 for example may comprise a high numerical aperture telescope. For example, the inventors have made a test where the distance d between object 9 and surface of the IR detector 7 was equal to 3 m and the optical system 11 comprised a lens with a diameter of 50 mm and a focal length of 70 mm. The lens formed a scaled down image of the object 9 at a distance of about 150 mm from the surface of the IR detector 7. This way, the reconstructed image of the object 9 extended substantially through the entire field of the view of the system 1. The end of the output optical fiber 3out2 emitting the reference beam R was also placed at a distance of about 150 mm from the surface of the IR detector 7, thereby creating an appropriate angle between object beam O and reference beam R, without the output optical fiber 3out2 intercepting the object beam O.

In addition, or alternatively, the second portable device 1b of the system 1′ optionally comprises a beam splitter 12 arranged to combine the reference beam R emitted by the output optical fiber 3out2 of the fiber optic splitter 3 and the object beam O scattered by the object 9. The beam splitter 12 is preferably located on the optical path of the reference beam R, between the end of the output optical fiber 3out2 emitting the reference beam R and the IR detector 7, so as to deflect the optical path of the reference beam R by a desired angle. By way of non-limiting example, in FIG. 4 the angle is substantially of 90°. The splitting ratio of the beam splitter 12 is preferably chosen, together with the splitting ratio of the fiber optic splitter 3, in order to obtain the desired intensities of the object beam O and reference beam R on the surface of the IR detector 7. Use of the beam splitter 12 allows providing a more compact interferometric arrangement, and hence a more compact second portable device 1b. In addition or alternatively, the second portable device 1b of the system 1′ optionally comprises an adjustable collimator 13 located at the end of the output optical fiber 3out1 emitting the object beam O.

The adjustable collimator 13 may comprise one or more lenses and it may be used for increasing or decreasing the size of the object beam O as output by the output optical fiber 3out1 of the fiber optic splitter 3.

In addition or alternatively, the second portable device 1b of the system 1′ optionally comprises an adjustable collimator 14 located at the end of the output optical fiber 3out2 emitting the reference beam R. The collimator 14 may comprise one or more lenses and it may be used for increasing or decreasing the size of the reference beam R as output by the output optical fiber 3out2 of the fiber optic splitter 3.

In addition or alternatively, the second portable device 1b of the system 1′ optionally comprises a variable attenuator 15 located on the optical path of the reference beam R, between the end of the output optical fiber 3out2 emitting the reference beam R and the IR detector 7. The variable attenuator 15 is adjustable such that the reference beam R and the object beam O scattered by the object 9 are received at the IR detector 7 with comparable intensities, when the two beams O, R have sufficiently high intensities, or such that the reference beam R is received with a higher intensity with respect to the object beam O, when the latter has a low intensity value. This allows optimizing the interference pattern of reference beam R and object beam O, namely the visibility of the interference fringes of the hologram. The variable attenuator 15 for example may comprise a polarizer 15a and a half-wave plate 15b. Alternatively, the variable attenuator 15 may comprise a neutral density filter.

The operation of the system 1′ may be either according to the flow chart of FIG. 2 or the flow chart of FIG. 3 described above.

1. A system for detecting an object at least partially hidden by a flame, the system comprising:
a first portable device comprising a fiber optic laser suitable for emitting an infrared radiation;
a second portable device comprising a fiber optic splitter optically coupled to the fiber optic laser and an infrared detector, the fiber optic splitter being configured to divide the infrared radiation into an object beam and a reference beam, to direct the object beam onto at least a portion of the object and to direct the reference beam onto the infrared detector, the infrared detector being configured to detect a hologram formed by the reference beam interfering with the object beam scattered by the at least a portion of the object,
wherein the system further comprises a data processing unit configured to reconstruct at least one image of the object by numerically processing the hologram and a display configured to visualize the at least one reconstructed image.

2. The system according to claim 1, wherein the first portable device is a backpack.

3. The system according to claim 1, wherein the second portable device is a handheld unit.

4. The system according to claim 1, wherein the infrared radiation has a wavelength lower than 3 μm and/or a maximum output power of 10 W.

5. The system according to claim 4, wherein the infrared radiation is linearly polarized.

6. The system according to claim 1, wherein the second portable device is provided with an outer casing having at least one opening provided with an optically transparent window capable of allowing passage of the infrared radiation in both directions.

7. The system according to claim 1, any of the pre ceding-claims, wherein the fiber optic laser is provided with an output optical fiber suitable for exiting the first portable device and for being removably coupled with the fiber optic splitter comprised in the second portable device.

8. The system according to claim 1, wherein the infrared detector has a frame rate up to 230 frame/s and/or a maximum exposure time of 500 μs.

9. The system according to claim 1, wherein the data processing unit is positioned in the first portable device or in the second portable device.

10. The system according to claim 1, wherein the display is positioned on the second portable device or in a third portable device other than the first portable device and second portable device.

11. The system according to claim 1, wherein the second portable device is provided with a stabilization system configured to reduce sensitivity to vibrations of the hologram formed by the reference beam interfering with the object beam scattered by the at least a portion of the object.

12. The system according to claim 1, wherein the second portable device further comprises at least one of:
an optical system suitable for maximizing the optical power of the object beam scattered by the object and directed to the infrared detector;
a beam splitter located on the optical path of the reference beam and configured to combine the reference beam and the object beam scattered by the object;
an adjustable collimator located on the optical path of the object beam and suitable for adjusting the size of the object beam directed onto at least a portion of the object;
a further adjustable collimator located on the optical path of the reference beam and suitable for adjusting the size of the reference beam; and
a variable attenuator located on the optical path of the reference beam and suitable for adjusting the intensity of the reference beam such that the reference beam and the object beam scattered by the object are received at the infrared detector with comparable intensities.

13. A method for detecting an object at least partially hidden by a flame, the method comprising:
by a fiber optic laser comprised in a first portable device, emitting an infrared radiation;
by a fiber optic splitter optically coupled to the fiber optic laser and comprised in a second portable device, dividing the infrared radiation into an object beam and a reference beam, directing the object beam onto at least a portion of the object and directing the reference beam onto an infrared detector also comprised in the second portable device;
by said infrared detector comprised in the second portable device, detecting a hologram formed by the reference beam interfering with the object beam scattered by the at least a portion of the object, and
by data processing unit, reconstructing at least one image of the object by numerically processing the hologram and a display configured to visualize the at least one reconstructed image.
